(19) United States
(12) Patent Application Publication
(10) Pub. No.: US 2007/0260928 A1
(43) Pub. Date: Nov. 8, 2007

(54) System and method for engineered decoupling in a development environment

(76) Inventors: Peter Zencke, Gorxheimertal (DE); Peter Mathias Lorenz, Dosseheim (DE); Rainer Paul Burghard Zinow, Neustadt (DE); Clemens Edmund Daeschle, Neckadrsteinach (DE); Volker Handwerk, Gruenstadt (DE); Clas Neumann, Bangalore (IN)

Correspondence Address: KENYON & KENYON LLP, 1500 K STREET N.W., WASHINGTON, DC, 20005, US

(21) Appl. No.: 11/342,699

(22) Filed: Jan. 31, 2006

(51) Int. Cl. G06F 11/00

(52) U.S. Cl. 714/38

(57) ABSTRACT

A system and method for providing engineered decoupling in a development environment. According to an embodiment of the invention, an infrastructure framework is configured to process one or more service requests from a frontend application, an actual runtime engine is associated with the infrastructure framework and configured to implement functionality for processing the one or more service requests, the actual runtime engine having development completed according to at least one development phase and under development according to a subsequent development phase, and a simulated runtime engine is associated with the infrastructure framework and configured to simulate at least a portion of the actual runtime engine as developed according to the at least one development phase.

### BACKGROUND OF THE INVENTION

Development of a complex software system usually starts with defining an object model that represents the desired structure and functionality of objects to be implemented in an application framework. In business software environments, these objects are sometimes referred to as “business objects”, which can be defined according to a node structure that may specify corresponding data elements and behaviors to be associated with the objects.

Once the object model is defined, developers are able to produce code for the application framework that implements the defined objects. The application framework acts as a service provider and generally provides the backend level functionality for the software system. Once completed, the developers are then able to focus on coding the frontend aspects of the software system, such as the user interface portion of the system which interfaces with and depends upon the backend level functionality.

Unfortunately, software systems developed in this manner do not make an efficient use of development resources, since different development teams usually are assigned to create the backend and frontend system components. Because the frontend system components cannot be created and tested until the backend system components are developed, the frontend system developers find themselves waiting until the backend system developers are finished before they can start working on the frontend. This results in a serial development process.

Thus, there is a need in the art for a system and method that improves the efficiency of application development in complex software systems.

### BRIEF DESCRIPTION OF THE DRAWINGS

FIG. 1 is a timeline that depicts a multi-front parallel development process in accordance with an embodiment of the present invention.

FIG. 2 is a block diagram that depicts a system architecture in accordance with an embodiment of the present invention.

FIG. 3 is a process flow diagram that depicts a service provider routing process in accordance with an embodiment of the present invention.

FIG. 4 is a block diagram that depicts the generation of a generic runtime simulation framework in accordance with an embodiment of the present invention.

FIG. 5 is a block diagram that depicts a computing device in accordance with an embodiment of the present invention.

### DETAILED DESCRIPTION

The present invention significantly reduces software development time by enabling frontend system developers to work in parallel with backend system developers. This may be achieved by providing frontend developers with a simulated backend runtime environment, which provides frontend developers with a mechanism to test frontend application service requests, while allowing the actual backend development to further continue.

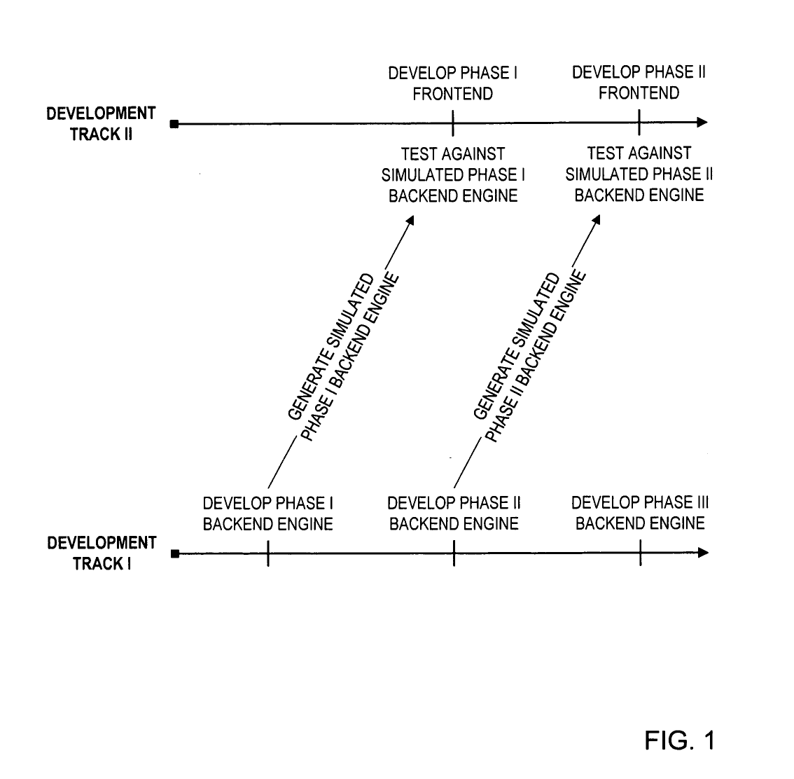

FIG. 1 illustrates an example of this achievement in accordance with distinct phases and tracks of software development. In development track I, backend developers structure the development of a backend engine in distinct phases, while in development track II, frontend developers structure the development of a frontend in distinct phases. Once the backend developers complete phase I of their backend engine development (e.g., defining a structure of business objects—e.g., quantity and delivery date of a sales order business object), a simulated backend engine may be generated for use by the frontend developers as a full or partial substitute for the actual backend, while the backend developers continue into phase II of their backend engine development (e.g., defining further constraints on the behavior of the business objects—e.g., defining all possible states of a business object, possible actions that can be performed on the object, the resulting new status, and pre-conditions in terms of statuses that have to be reached to perform a certain action). This process may repeat for however many development phases a development team chooses to have.

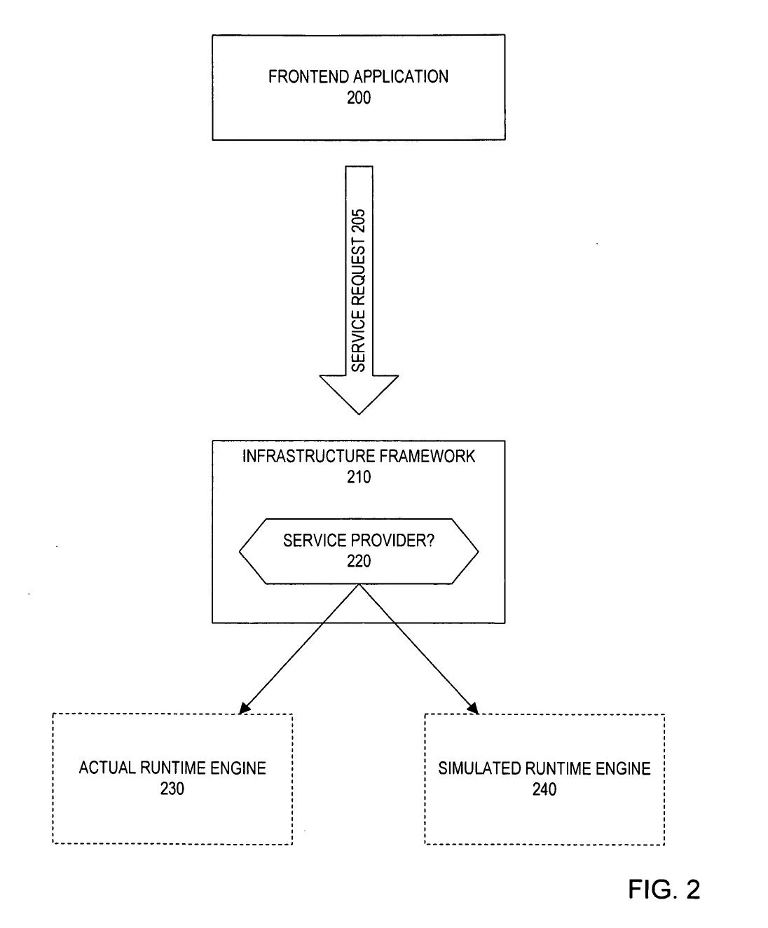

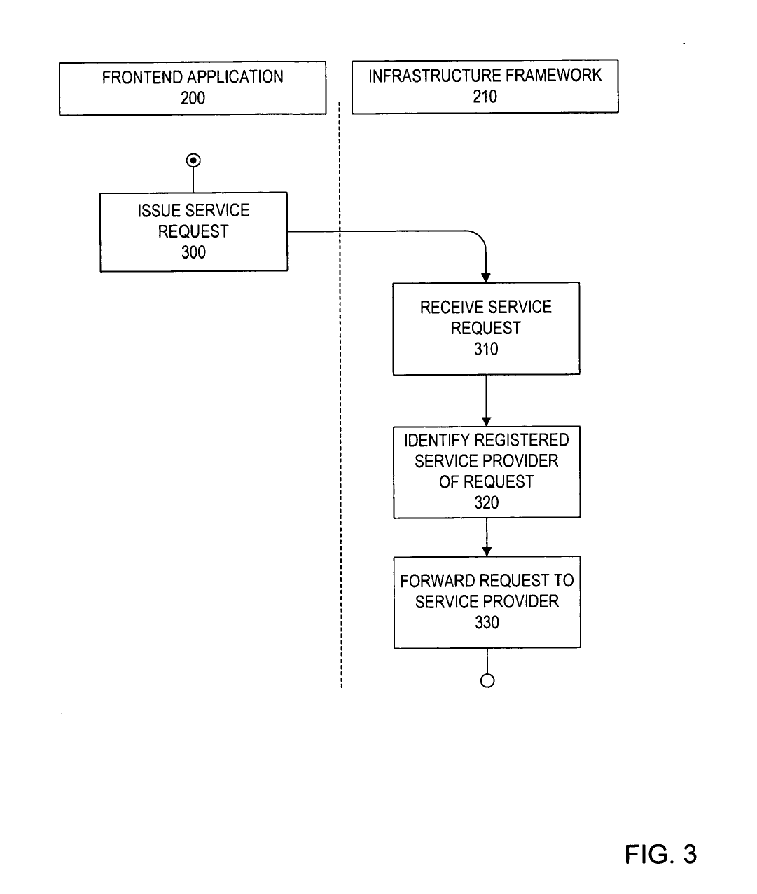

FIGS. 2 and 3 depict a system architecture and service provider routing process in accordance with an embodiment of the present invention. In the testing process, frontend application 200 issues a service request (205) to the underlying infrastructure framework (210) (step 300). Once infrastructure framework 210 receives the request (step 310), it identifies which underlying environment—the actual runtime engine (230) or the simulated runtime engine (240)—is registered to act as the service provider (220) for this request (step 320). Upon making this determination, infrastructure framework 210 subsequently forwards the request to the appropriate service provider for processing (step 330).

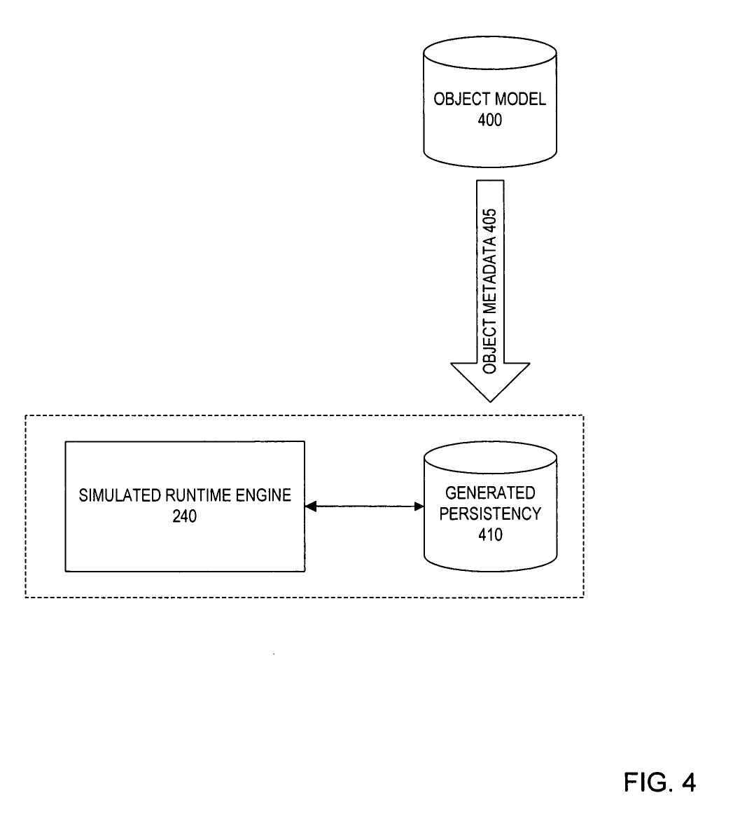

FIG. 4 depicts how a generic runtime simulation framework may be generated in accordance with an embodiment of the present invention. Due to the generic nature of the simulated runtime engine (240), it may be the case that the simulated runtime engine (240) itself is not developed or generated with the knowledge of any particular object or its functionality. Rather, it may include a set of services (e.g., add, delete, update business object attributes etc.) that simulate certain actual runtime engine functionality for any type of business object that is defined according to a particular structure that the simulated runtime engine (240) is expecting. Thus, in this embodiment object metadata 405 (e.g., node structure, attributes, etc. pertaining to particular business objects) from an object model repository (400) need only be extracted and persisted in database 410 in order to provide the full generic runtime simulation framework.

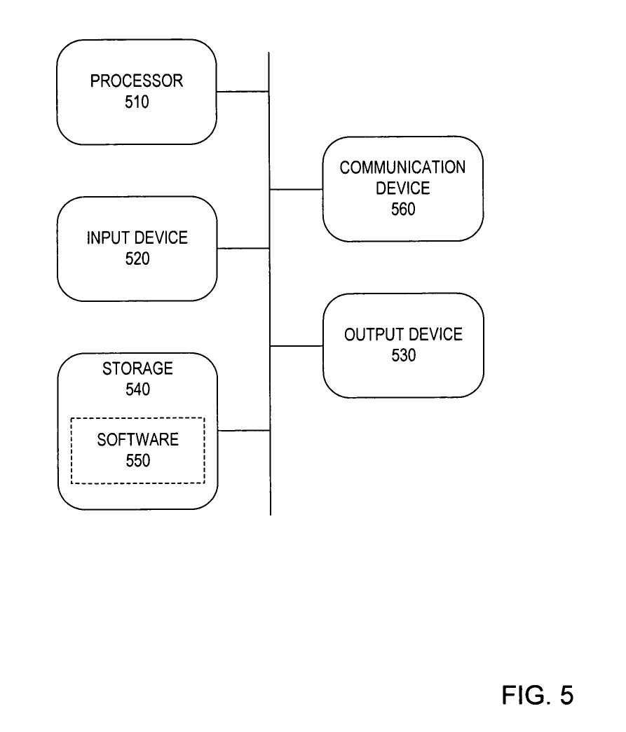

FIG. 5 illustrates the components of a basic computing device in accordance with an embodiment of the present invention. The computing device may be a personal computer, workstation, handheld personal digital assistant (“PDA”), server, or any other type of microprocessor-based device. The computing device may include one or more of processor 510, input device 520, output device 530, storage 540, and communication device 560.

Input device 520 may include a keyboard, mouse, pen-operated touch screen or monitor, voice-recognition device, or any other device that provides input. Output device 530 may include a monitor, printer, disk drive, speakers, or any other device that provides output.

Storage 540 may include volatile and nonvolatile data storage, including one or more electrical, magnetic or optical memories such as a RAM, cache, hard drive, CD-ROM drive, tape drive or removable storage disk. Communication device 560 may include a modem, network interface card, or any other device capable of transmitting and receiving signals over a network. The components of the computing device may be connected in any manner, such as via electrical bus or wirelessly.

Software 550, which may be stored in storage 540 and executed by processor 510, may include, for example, the application programming that embodies the functionality of the present invention. Software 550 may include a combination of client applications and enterprise servers such as an application server and a database server.

The computing device may communicate within or over any network, which may include any type of interconnected communication system, which may implement any communications protocol, and which may be secured by any security protocol. Any corresponding network links may include telephone lines, DSL, cable networks, T1 or T3 lines, wireless network connections, or any other arrangement that implements the transmission and reception of network signals.

The computing device may implement any operating system, such as Windows or UNIX. Software 550 may be written in any programming language, such as ABAP, C, C++, lava or Visual Basic. In various embodiments, application software embodying the functionality of the present invention may be deployed on a standalone machine, in a client/server arrangement or through a Web browser as a Web-based application or Web service, for example.

Several embodiments of the invention are specifically illustrated and/or described herein. However, it will be appreciated that modifications and variations of the invention are covered by the above teachings and within the purview of the appended claims without departing from the spirit and intended scope of the invention.

For example, software modules that implement the present invention may comprise several discrete modules that together still provide the same functionality, data specified in the referenced data stores (such as generated persistency 410, for example) may be spread over several databases and/or systems, and the flow diagram of FIG. 3 may encompass combined steps or several intermediate steps that do not detract from the higher level functionality described therein.

What is claimed is:

1. A system for providing engineered decoupling in a development environment, comprising:
an infrastructure framework configured to process one or more service requests from a frontend application;
an actual runtime engine associated with the infrastructure framework and configured to implement functionality for processing the one or more service requests, the actual runtime engine having development completed according to at least one development phase and under development according to a subsequent development phase; and
a simulated runtime engine associated with the infrastructure framework and configured to simulate at least a portion of the actual runtime engine as developed according to the at least one development phase.

2. The system of claim 1, wherein the infrastructure framework is configured to determine whether the actual runtime engine or the simulated runtime engine is to process the one or more service requests.

3. The system of claim 2, wherein the determination is made by accessing a table mapping the one or more service requests with the particular runtime engine to process the one or more service requests.

4. The system of claim 2, wherein the infrastructure framework is configured to forward the one or more service requests to the determined runtime engine for processing.

5. The system of claim 1, wherein the one or more service requests communicate with the infrastructure framework via an interface defined at least in part by a set of one or more business objects.

6. The system of claim 5, wherein both the actual runtime engine and the simulated runtime engine are configured to process service requests defined in accordance with the same communications interface.

7. The system of claim 1, wherein the simulated runtime engine is configured to process the one or more service requests based on metadata generated from an object model defining one or more business objects associated with the one or more service requests.

8. The system of claim 7, wherein the frontend application includes a presentation engine corresponding to a user interface.

9. The system of claim 8, wherein the one or more service requests originate from user input via the user interface.

10. A development system for providing decoupled development platforms between frontend and backend components of an integrated software system, comprising:
an infrastructure framework responsive to a service request from a frontend application to route the service request to a backend service; and
a simulated runtime engine corresponding to the backend service, wherein the infrastructure framework comprises a development routing switch that when activated routes the service request to the simulated runtime engine instead of the backend service.

11. A computer-implemented method for providing engineered decoupling in a development environment, comprising:
receiving by an infrastructure framework one or more service requests from a frontend application;
determining whether an actual or simulated runtime engine is to process the one or more service requests; and
forwarding by the infrastructure framework the one or more requests to the determined runtime engine for processing.

12. The method of claim 11, wherein the actual runtime engine is associated with the infrastructure framework and configured to implement functionality for processing the one or more service requests, the actual runtime engine having development completed according to at least one development phase and under development according to a subsequent development phase.

13. The method of claim 11, wherein the simulated runtime engine is associated with the infrastructure framework and configured to simulate at least a portion of the actual runtime engine as developed according to the at least one development phase.

14. The method of claim 11, wherein the determination is made by accessing a table mapping the one or more service requests with the particular runtime engine to process the one or more requests.

15. The method of claim 11, wherein the one or more service requests communicate with the infrastructure framework via an interface defined at least in part by a set of one or more business objects.

16. The method of claim 15, wherein both the actual runtime engine and the simulated runtime engine are configured to process service requests defined in accordance with the same communications interface.

17. A system for providing engineered decoupling in a development environment, comprising:
means for receiving by an infrastructure framework one or more service requests from a frontend application;
means for determining whether an actual or simulated runtime engine is to process the one or more service requests, wherein
the actual runtime engine is associated with the infrastructure framework and configured to implement functionality for processing the one or more service requests, the actual runtime engine having development completed according to at least one development phase and under development according to a subsequent development phase, and
the simulated runtime engine is associated with the infrastructure framework and configured to simulate at least a portion of the actual runtime engine as developed according to the at least one development phase; and
means for forwarding by the infrastructure framework the one or more requests to the determined runtime engine for processing.
